(19) United States
(12) Patent Application Publication
(10) Pub. No.: US 2016/0308427 A1
(43) Pub. Date: Oct. 20, 2016

(54) OPTIMUM ROTOR SKEW ANGLE FOR AN ELECTRIC MACHINE

(71) Applicant: GM GLOBAL TECHNOLOGY OPERATIONS LLC, Detroit, MI (US)

(72) Inventor: Avoki M. Omekanda, Rochester, MI (US)

(73) Assignee: GM GLOBAL TECHNOLOGY OPERATIONS LLC, Detroit, MI (US)

(21) Appl. No.: 15/191,652

(22) Filed: Jun. 24, 2016

Related U.S. Application Data
(63) Continuation-in-part of application No. 13/782,320, filed on Mar. 1, 2013.

(51) Int. Cl. H02K 17/16

(52) U.S. Cl. CPC H02K 17/165

(57) ABSTRACT

An electric machine assembly includes a stator core, a rotor assembly and a controller. The stator core defines a number of stator slots extending along a longitudinal axis and angularly spaced about the longitudinal axis. The rotor assembly is rotatable relative to the stator core and includes a plurality of laminations stacked between first and second ends of the rotor assembly. The laminations are skewed relative to each other. Each respective one of the plurality of laminations defines a number of rotor slots positioned along an outer periphery. The controller includes a processor and tangible, non-transitory memory on which is recorded instructions for executing a method of obtaining an optimal rotor skew angle. The optimum rotor skew angle is selected from a set (SK) of skew angles between first and second skew angles (SK₁≦SK≦SK₂).

### CROSS-REFERENCE TO RELATED APPLICATIONS

This application is a continuation-in-part of U.S. patent application Ser. No. 13/782,320, filed on Mar. 1, 2013, the disclosure of which is hereby incorporated by reference.

### TECHNICAL FIELD

The present disclosure relates generally to an electric machine, and more particularly, to an optimal configuration for the rotor assembly in the electric machine.

### BACKGROUND

An electric machine generally includes a rotor assembly that is rotatable relative to a stator assembly. To reduce torque ripple and cogging torque, the rotor or stator assemblies may be skewed. Different skew angles have different effects on the functioning of a particular electric machine. The optimal skew angle for a particular rotor assembly is not obvious.

### SUMMARY

An electric machine assembly includes a stator core, a rotor assembly and a controller. The stator core defines a number of stator slots extending along a longitudinal axis and angularly spaced about the longitudinal axis. The rotor assembly is rotatable relative to the stator core and includes a plurality of laminations stacked between first and second ends of the rotor assembly. The laminations are skewed relative to each other. Each respective one of the plurality of laminations defines a number of rotor slots positioned along an outer periphery. The controller includes a processor and tangible, non-transitory memory on which is recorded instructions for executing a method of obtaining an optimal rotor skew angle. The optimal rotor skew angle results in reduced acoustic noise and vibration.

The controller is programmed to obtain a stator slot pitch (SSP) as 360 divided by the number of stator slots and a rotor slot pitch (RSP) as 360 divided by the number of rotor slots in each respective one of the plurality of laminations. The controller is programmed to obtain a first skew angle (SK₁) as a minimum of the stator slot pitch and the rotor slot pitch such that SK₁=MINIMUM [SSP, RSP]. The controller is programmed to obtain a second skew angle (SK₂) as a maximum of the stator slot pitch and the rotor slot pitch such that SK₂=MAXIMUM [SSP, RSP]. The optimum rotor skew angle is selected from a set (SK) of skew angles between the first and second skew angles (SK₁≦SK≦SK₂).

The controller may be programmed to obtain a respective radial force for each of the set (SK) of skew angles between the first and second skew angles (SK₁≦SK≦SK₂) and identify a third skew angle (SK₃) from the set (SK) corresponding to a minimum value of the radial force. The respective radial force may be determined by finite element analysis (FEA).

The controller may be programmed to obtain a respective torque ripple for each of a set (SK) of skew angles between the first and second skew angles (SK₁≦SK≦SK₂) and identify a fourth skew angle (SK₄) from the set (SK) corresponding to a minimum value of the respective torque ripple. The optimum rotor skew angle is selected as a minimum of the third and fourth skew angles such that: SK_{OPT}=MINIMUM [SK₃, SK₄].

Obtaining the respective torque ripple for each of a set (SK) of skew angles may include obtaining a respective maximum torque (Tₘₐₓ), respective minimum torque (Tₘᵢₙ) and respective average torque (T_{avg}) for each of the set (SK) of skew angles. The respective torque ripple (TR) may be obtained as a function of the respective maximum torque (Tₘₐₓ), the respective minimum torque (Tₘᵢₙ) and the respective average torque (T_{avg}) such that: TR=[100*(Tₘₐₓ−Tₘᵢₙ)/T_{avg}].

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic partly-sectional view of an electric machine assembly having a rotor assembly and a controller;

FIG. 2 is a schematic fragmentary perspective view of the rotor assembly of the electric machine;

FIG. 3 is a flowchart stored on and executable by the controller of FIG. 1;

FIG. 4 is an example graph showing radial force as a function of rotor skew angle; and

FIG. 5 is an example of a plurality of traces of torque values as a function of rotor skew angle.

### DETAILED DESCRIPTION

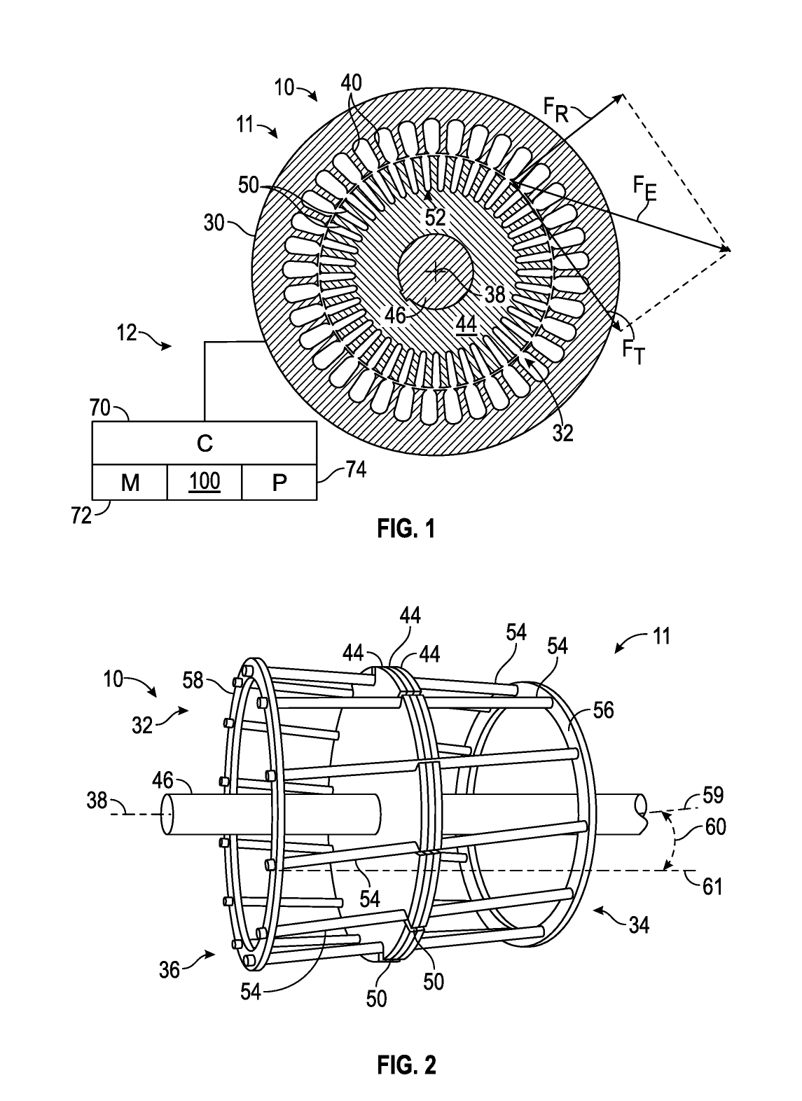

Referring to the Figures, wherein like reference numbers refer to the same or similar components throughout the several views, FIG. 1 is a schematic diagram of a an electric machine 10 in an electric machine assembly 11. The electric machine 10 may include any device configured to generate an electric machine torque by, for example, converting electrical energy into rotational motion or vice-versa. The electric machine 10 may be an electric motor/generator, an electric traction machine, an induction or asynchronous alternating current machine where power is supplied to the rotor with electromagnetic induction. The electric machine 10 may be part of a vehicle 12, which may take many different forms and include multiple and/or alternate components and facilities. While an example electric machine 10 is shown in the Figures, the components illustrated in the Figures are not intended to be limiting.

Referring to FIG. 1, the electric machine 10 includes a stator core 30 and a rotor assembly 32. Referring to FIG. 1, the rotor assembly 32 is positioned at least partially within the stator core 30 about a longitudinal axis 38 and is rotatable relative to the stator core 30.

Referring to FIG. 1, the stator core 30 defines a plurality of stator slots 40 extending lengthwise along the longitudinal axis 38 (extending out of the page in FIG. 1) and angularly spaced about the longitudinal axis 38. The number of stator slots 40 in the stator core 30 is referred to herein as “S.” Referring to FIG. 1, the stator slots 40 may be evenly spaced from each other radially about the longitudinal axis 38. Stator coils or windings (not shown) may be positioned in each of the stator slots 40.

FIG. 2 is a schematic fragmentary perspective view of the rotor assembly 32. Referring to FIG. 2, the rotor assembly 32 includes a plurality of laminations 44 stacked between first and second ends 34, 36 of the rotor assembly 32. For clarity, only a few laminations 44 are shown in FIG. 2. Referring to FIGS. 1-2, the laminations 44 may be positioned around a shaft 46. In one example, the laminations 44 are circular disks made of flat sheets of silicon steel. The sheets, which may be made of other suitable materials, are fitted into a punching die (not shown) which punches holes into the sheet resulting in a generally ring-like shape. Other suitable non-circular shapes may also be employed.

Referring to FIG. 1, each lamination 44 defines a number of rotor slots 50 positioned along an outer periphery 52. The number of rotor slots 50 in each lamination 44 is referred to herein as “R.” Each lamination 44 has the same number (R) of rotor slots 50. Referring to FIG. 2, conducting bars 54, referred to herein as rotor bars 54, may be positioned in each of the rotor slots 50. Each rotor slot 50 is configured to receive one of the rotor bars 54. The rotor bars 54 may be composed of any suitable conducting material, including but not limited to, copper, aluminum, brass etc. Alternatively, windings or coils (not shown) may be placed in the rotor slots 50.

The operation of the electric machine 10 depends on the interaction between two magnetic fields. In the case where the electric machine 10 is an induction motor, these magnetic fields result from current flowing in the stator windings (not shown) and in the rotor bars 54. The current in the stator windings produce a rotating magnetic field which sweeps past the rotor bars 54 and induces a force in them. As a result, an induced current flows in the rotor bars 54 and first and second end rings 56, 58 of the rotor assembly 32. The induced current in the rotor assembly 32 establishes its own magnetic field, which interacts with the magnetic field of the stator core 30. Referring to FIG. 1, an electromagnetic force (labeled F_{E} in FIG. 1) is exerted on the rotor assembly 32 at each point on the outer periphery 52. The electromagnetic force (F_{E}) includes a tangential force (labeled F_{T} in FIG. 1) that causes the rotor assembly 32 to turn. The electromagnetic force (F_{E}) includes a radial force (labeled F_{R} in FIG. 1). The radial force (F_{R}) does not contribute to the torque of the electric machine 10.

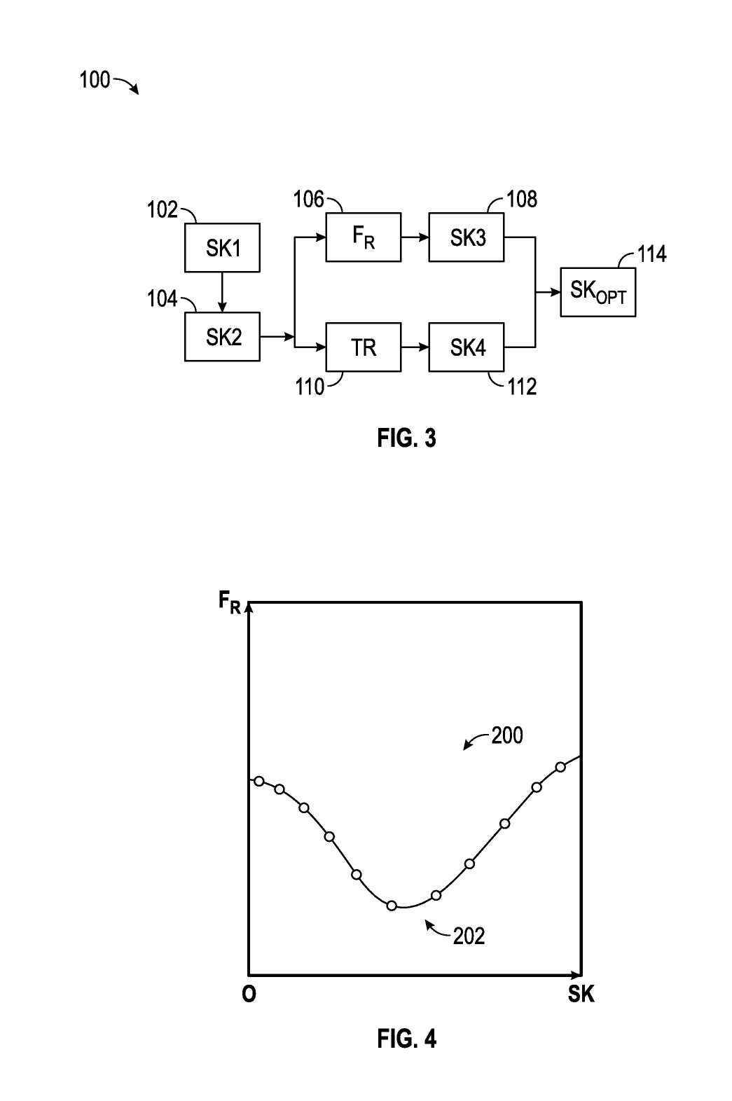

Referring to FIG. 1, a controller 70 (C) is operatively connected to the stator core 30 and rotor assembly 32. The controller 70 includes a processor 72 (P) and tangible, non-transitory memory 74 (M) on which is recorded instructions for executing a method 100, described below with reference to FIG. 3, of obtaining an optimum rotor skew angle 60. Referring to FIG. 2, the laminations 44 may be skewed relative to each other such that an angular position of a rotor bar 54 is different at the first end 34 of the rotor assembly 32 relative to the angular position of that rotor bar 54 at the second end 36 of the rotor assembly 32. Referring to FIG. 2, the optimum rotor skew angle 60 is defined by the angle subtended by a first line 59 that is parallel to a rotor bar 54 and a second line 61 that is parallel to the longitudinal axis 38.

Referring now to FIG. 3, a flowchart of the method 100 stored on and executable by the controller 70 of FIG. 1 is shown. Method 100 need not be applied in the specific order recited herein and it is to be understood that some steps may be eliminated. Method 100 may begin with block 102, in which the controller 70 is programmed to obtain a first skew angle (SK₁) as a minimum of a stator slot pitch (SSP) and a rotor slot pitch (RSP) such that SK₁=MIN [SSP, RSP]. The stator slot pitch (SSP) is defined as 360 divided by the number of stator slots 40 (S). The rotor slot pitch (RSP) is defined as 360 divided by the number of rotor slots 50 (R) in each lamination 44 (each lamination 44 has the same number of rotor slots 50). Stated differently:

$$First Skew Angle ( {SK}_{1} ) = MINIMUM [ \frac{360}{S} , \frac{360}{R} ]$$

In block 104, the controller 70 is programmed to obtain a second skew angle (SK₂) as a maximum of the stator slot pitch and the rotor slot pitch such that SK₂=MAX [SSP, RSP]. Stated differently:

$$Second Skew Angle ( {SK}_{2} ) = MAXIMUM [ \frac{360}{S} , \frac{360}{R} ]$$

In block 106, the controller 70 is programmed to obtain a respective radial force (F_{R}) for each of a set (SK) of skew angles between (inclusive) the first and second skew angles (SK₁≦SK≦SK₂). FIG. 4 is an example graph 200 showing radial force (F_{R}) as a function of the set (SK) of skew angles. The radial force (F_{R}) for the set (SK) of skew angles may be determined via analytical methods, finite element method (FEM) or any other method known to those skilled in the art. As understood by those skilled in the art, finite element method (FEM) (also known as finite element analysis (FEA)) is a numerical analysis method for finding approximate solutions to boundary value problems for partial differential equations by dividing a large problem into smaller parts. As understood by those skilled in the art, the calculation of radial force (F_{R}) in FEM may involve the use the Maxwell stress tensor method. A commercial platform, such as ANSYS 10.0, may be employed.

The method 100 proceeds to block 108, where the controller 70 is programmed to identify a third skew angle (SK₃) from the set (SK) corresponding to a minimum value 202 (see FIG. 4) of the radial force (F_{R}).

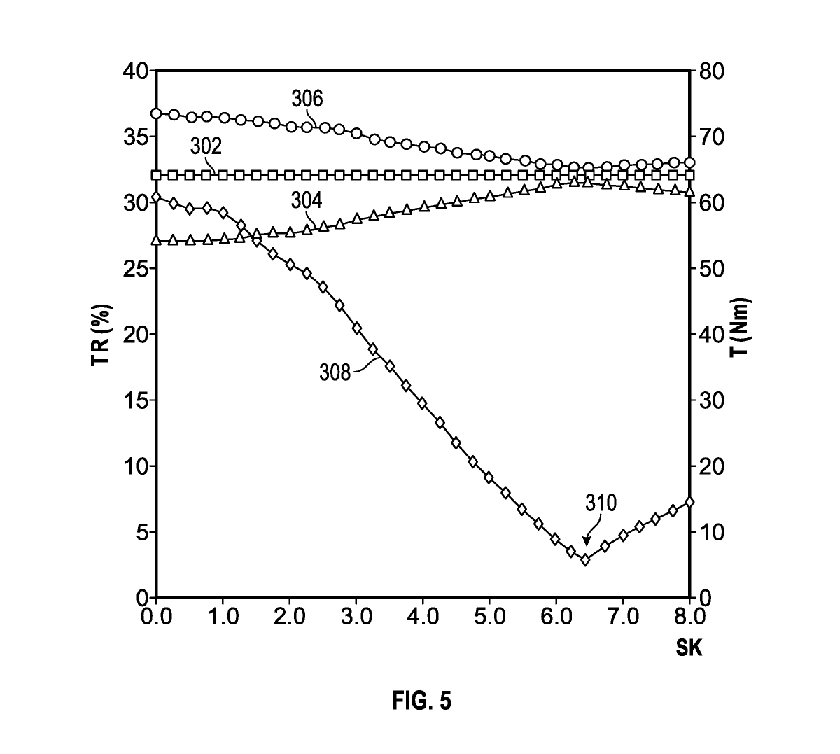

In block 110 of FIG. 3, the controller 70 is programmed to obtain a respective torque ripple (TR) for each of the set (SK) of skew angles between (inclusive) the first and second skew angles (SK₁≦SK≦SK₂). The respective torque ripple (TR) for the set (SK) of skew angles may be determined via analytical methods, the finite element method (FEM) or finite element analysis (FEA), or any other method known to those skilled in the art. FIG. 5 illustrates a plurality of traces of torque values as a function of the set (SK) of skew angles. Traces 302, 304, 306 illustrate the maximum torque (Tₘₐₓ), the minimum torque (Tₘᵢₙ) and the average torque (T_{avg}), respectively, for each of the set (SK) of skew angles. The respective torque ripple (TR) may be obtained as a function of the respective maximum torque (Tₘₐₓ), the respective minimum torque (Tₘᵢₙ), and the respective average torque (T_{avg}) such that:

TR=[100*(Tₘₐₓ−Tₘᵢₙ)/T_{avg}].

Referring to FIG. 5, trace 308 shows torque ripple 308 as a function of the set (SK) of skew angles. The method 100 proceeds to block 112, where the controller 70 is programmed to identify a fourth skew angle (SK₄) from the set (SK) corresponding to a minimum value 310 of the torque ripple.

In block 114, the controller 70 is programmed to select the optimum rotor skew angle (SK_{OPT}) as a minimum of the third and fourth skew angles such that:

SK_{OPT}=MINIMUM[SK₃,SK₄].

The method 100 improves the functioning of the electric machine 10 by identifying an optimal rotor skew angle 60 for reducing unwanted vibration and noise. The precise skew angle that would optimally reduce unwanted vibration and noise is not an obvious determination.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. An electric machine assembly comprising:
a stator core defining a number of stator slots extending along a longitudinal axis and angularly spaced about the longitudinal axis;
a rotor assembly rotatable relative to the stator core and including a plurality of laminations stacked between first and second ends of the rotor assembly;
wherein the plurality of laminations are skewed relative to each other;
wherein each respective one of the plurality of laminations defines a number of rotor slots positioned along an outer periphery;
a controller operatively connected to the stator core and the rotor assembly, the controller including a processor and tangible, non-transitory memory on which is recorded instructions for executing a method for obtaining an optimal rotor skew angle;
wherein execution of the instructions by the processor causes the controller to:
obtain a stator slot pitch (SSP) as 360 divided by the number of stator slots;
obtain a rotor slot pitch (RSP) as 360 divided by the number of rotor slots in said each respective one of the plurality of laminations;
obtain a first skew angle (SK₁) as a minimum of the stator slot pitch and the rotor slot pitch such that SK₁=MINIMUM [SSP, RSP];
obtain a second skew angle (SK₂) as a maximum of the stator slot pitch and the rotor slot pitch such that SK₂=MAXIMUM [SSP, RSP]; and
select the optimum rotor skew angle from a set (SK) of skew angles between the first and second skew angles (SK₁≦SK≦SK₂).

2. The assembly of claim 1, wherein the controller is programmed to:
obtain a respective radial force for each of the set (SK) of skew angles between the first and second skew angles (SK₁≦SK≦SK₂); and
identify a third skew angle (SK₃) from the set (SK) corresponding to a minimum value of the radial force.

3. The assembly of claim 2, wherein the respective radial force is determined by finite element analysis (FEA).

4. The assembly of claim 2, wherein the controller is programmed to:
obtain a respective torque ripple for each of a set (SK) of skew angles between the first and second skew angles (SK₁≦SK≦SK₂);
identify a fourth skew angle (SK₄) from the set (SK) corresponding to a minimum value of the respective torque ripple; and
select the optimum rotor skew angle as a minimum of the third and fourth skew angles such that SK_{OPT}=MINIMUM [SK₃, SK₄].

5. The assembly of claim 4, wherein said obtaining a respective torque ripple for each of a set (SK) of skew angles includes:
obtaining a respective maximum torque (Tₘₐₓ), respective minimum torque (Tₘᵢₙ) and respective average torque (T_{avg}) for each of the set (SK) of skew angles; and
obtaining the respective torque ripple (TR) as a function of the respective maximum torque (Tₘₐₓ), the respective minimum torque (Tₘᵢₙ) and the respective average torque (T_{avg}) such that:
TR=[100*(Tₘₐₓ−Tₘᵢₙ)/T_{avg}].

6. A method of obtaining an optimum rotor skew angle in an electric machine having a stator core and a rotor assembly, the stator core defining a number of stator slots extending along a longitudinal axis and angularly spaced about the longitudinal axis, the rotor assembly including a plurality of laminations stacked between first and second ends of the rotor assembly, each respective one of the plurality of laminations defining a number of rotor slots positioned along an outer periphery, the method comprising:
obtaining a stator slot pitch (SSP) as 360 divided by the number of stator slots;
obtaining a rotor slot pitch (RSP) as 360 divided by the number of rotor slots in said each respective one of the plurality of laminations;
obtaining a first skew angle (SK₁) as a minimum of the stator slot pitch and the rotor slot pitch such that SK₁=MINIMUM [SSP, RSP];
obtaining a second skew angle (SK₂) as a maximum of the stator slot pitch and the rotor slot pitch such that SK₂=MAXIMUM [SSP, RSP]; and
selecting the optimum rotor skew angle from a set (SK) of skew angles between the first and second skew angles (SK₁≦SK≦SK₂).

7. The method of claim 6, further comprising:
obtaining a respective radial force for each of the set (SK) of skew angles between the first and second skew angles (SK₁≦SK≦SK₂); and
identifying a third skew angle (SK₃) from the set (SK) corresponding to a minimum value of the radial force.

8. The method of claim 7, wherein the respective radial force is determined by finite element analysis (FEA).

9. The method of claim 7, further comprising:
obtaining respective torque ripple for the set (SK) of skew angles between the first and second skew angles (SK₁≦SK≦SK₂);
identifying a fourth skew angle (SK₄) from the set (SK) corresponding to a minimum of the respective torque ripple; and
selecting the optimum rotor skew angle (SK_{OPT}) as a minimum of the third and fourth skew angles such that SK_{OPT}=MINIMUM [SK₃, SK₄].

10. The method of claim 9, wherein said obtaining a respective torque ripple for each of a set (SK) of skew angles includes:
obtaining respective maximum torque (Tₘₐₓ), respective minimum torque (Tₘᵢₙ) and respective average torque (T_{avg}) for each of the set (SK) of skew angles; and
obtaining the respective torque ripple (TR) as a function of the respective maximum torque (Tₘₐₓ), the respective minimum torque (Tₘᵢₙ) and the respective average torque (T_{avg}) such that:
TR=[100*(Tₘₐₓ−Tₘᵢₙ)/T_{avg}].

11. A method of obtaining an optimum rotor skew angle in an electric machine having a stator core and a rotor assembly, the stator core defining a number of stator slots extending along a longitudinal axis and angularly spaced about the longitudinal axis, the rotor assembly including a plurality of laminations stacked between first and second ends of the rotor assembly, each respective one of the plurality of laminations defining a number of rotor slots positioned along an outer periphery, the method comprising:
obtaining a stator slot pitch (SSP) as 360 divided by the number of stator slots;
obtaining a rotor slot pitch (RSP) as 360 divided by the number of rotor slots in said each respective one of the plurality of laminations;
obtaining a first skew angle (SK₁) as a minimum of the stator slot pitch and the rotor slot pitch such that SK₁=MINIMUM [SSP, RSP];
obtaining a second skew angle (SK₂) as a maximum of the stator slot pitch and the rotor slot pitch such that SK₂=MAXIMUM [SSP, RSP];
obtaining a respective radial force for each of a set (SK) of skew angles between the first and second skew angles (SK₁≦SK≦SK₂);
obtaining a respective torque ripple for each of a set (SK) of skew angles between the first and second skew angles (SK₁≦SK≦SK₂);
identifying a third skew angle (SK₃) from the set (SK) corresponding to a minimum value of the radial force;
identifying a fourth skew angle (SK₄) from the set (SK) corresponding to a minimum value of the torque ripple; and
selecting the optimum rotor skew angle as a minimum of the third and fourth skew angles such that SK_{OPT}=MINIMUM [SK₃, SK₄].

12. The method of claim 11, wherein said obtaining a respective torque ripple for each of a set (SK) of skew angles includes:
obtaining respective maximum torque (Tₘₐₓ), respective minimum torque (Tₘᵢₙ) and respective average torque (T_{avg}) for each of the set (SK) of skew angles; and
obtaining the respective torque ripple (TR) as a function of the respective maximum torque (Tₘₐₓ), the respective minimum torque (Tₘᵢₙ) and the respective average torque (T_{avg}) such that:
TR=[100*(Tₘₐₓ−Tₘᵢₙ)/T_{avg}].
